(19) United States
(12) Patent Application Publication
(10) Pub. No.: US 2009/0159037 A1
(43) Pub. Date: Jun. 25, 2009

(54) Multi-Part Piston For An Internal Combustion Engine

(76) Inventor: Dieter Messmer, Remseck (DE)

Correspondence Address: COLLARD & ROE, P.C., 1077 NORTHERN BOULEVARD, ROSLYN, NY, 11576, US

(21) Appl. No.: 12/225,130

(22) PCT Filed: Mar. 23, 2007
(86) PCT No.: PCT/DE2007/000533

§ 371 Date: Sep. 15, 2008

(30) Foreign Application Priority Data
Mar. 25, 2006 (DE) 10 2006 013 906.2

(51) Int. Cl. F02F 3/00

(52) U.S. Cl. 123/193.6

(57) ABSTRACT

The invention relates to a multipart piston (10) for an internal combustion engine, comprising a piston top (11) and a piston base (12), the piston base (12), on its side facing the piston top (11), having a supporting disk (32). The invention is characterized in that the piston top (11), on its side facing the piston base (12), has a threaded bore (31), the supporting disk (32), on its side facing away from the piston top (11), has a radial contact surface (34) against which a corresponding radial contact surface (36) configured on a screw (35) rests, and in that the screw (35) is screwed into the threaded bore (31).

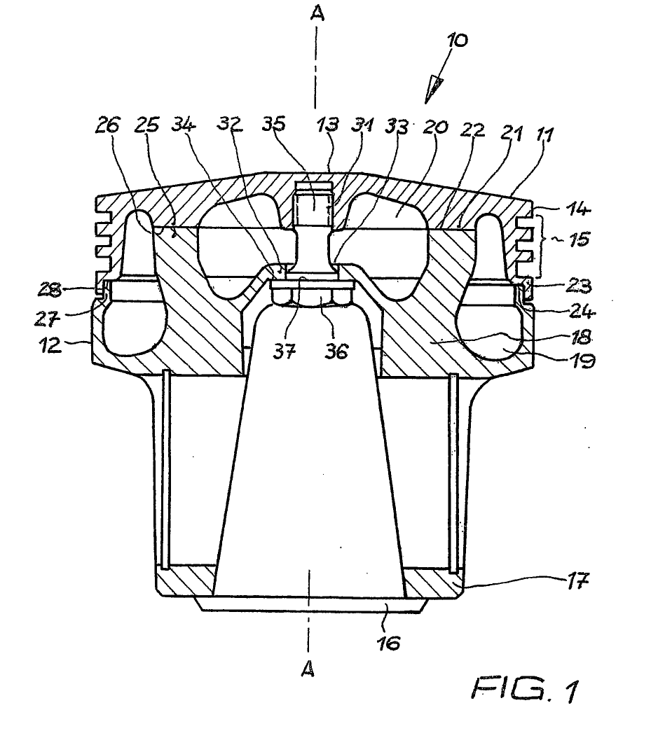

The present invention relates to a multi-part piston for an internal combustion engine, having an upper piston part and a lower piston part, whereby the lower piston part has a support plate on its side facing the upper piston part.

Multi-part pistons have the great advantage that the upper piston part and the lower piston part can consist of different materials. The upper piston part is generally produced from a particularly wear-resistant material, particularly one that is heat-resistant, but relatively heavy, while the lower piston part is generally produced from a light-metal material that is less wear-resistant, in order to save weight. In this connection, the upper piston part and the lower piston part can be connected with one another by means of being screwed together, as disclosed in EP 1 483 493 B1.

A piston of the type stated is described in DE 102 57 022 A1. It has a threaded head affixed to the upper piston part, and a support plate affixed to the lower piston part, having a threaded body that corresponds to the threaded head, which are screwed to one another during assembly of the piston. In this connection, the support plate provided with the threaded body is domed in the manner of a disk spring, so that a tensile stress is exerted on the threaded head, which stress brings about a permanent assembly connection between the upper piston part and the lower piston part.

It is problematical in this connection that the tensile stress can become so great that when the upper piston part and the lower piston part are screwed together, the threaded bore can widen out as a result of the tensile forces, which are directed vertically upward. As a result, the screw connection is destabilized, in the final analysis. This can go so far that the support plate is deformed or even destroyed, or the screw connection is torn apart.

The task of the present invention consists in making available a piston of this type, in which the upper piston part and the lower piston part are connected with one another by means of a screw connection, in stable manner, whereby the screw connection is not impaired.

The solution consists in a piston having the characteristics of claim 1.

According to the invention, it is provided that the upper piston part is provided with a threaded bore on its side facing the lower piston part, that the support plate has a radial contact surface on its side facing away from the upper piston part, against which surface a corresponding radial contact surface formed on a screw rests, and that the screw is screwed into the threaded bore.

The configuration according to the invention is characterized in that the upper piston part and the lower piston part are screwed to one another with a separate screw, whereby the threaded bore into which the screw engages is provided in the upper piston part. At the same time, a contact surface formed on the screw rests against a corresponding contact surface formed on the underside of the support plate. The screw is therefore screwed into the upper piston part “from below,” in other words from the direction of the lower piston part. The upper piston part is therefore drawn “downward,” in other words in the direction of the lower piston part, by means of the forces that result by means of the screw connection, in that the screw is supported on the underside of the support plate. In this connection, the screw is lengthened slightly. The force is therefore passed directly into the lower piston part, from the screw, by way of the support plate. The screw connection in the upper piston part therefore remains stable, and is not impaired by the forces that occur, particularly not loosened.

Advantageous further developments are evident from the dependent claims.

A preferred further development provides that the support plate is configured elastically. The elastic bias of upper piston part and lower piston part is optimized. The elasticity of the support plate and the lengthening of the screw during the screwing-in process additionally strengthen the screw connection.

The threaded bore should be configured as a dead-end bore, in order to keep the piston crown closed.

A preferred further development provides that the lower piston part has an inner circumferential support element, and that the support plate is connected with the inner support element. In this manner, the piston can be provided both with an outer and with an inner circumferential cooling channel.

In order to have the upper piston part and the lower piston part support one another in the assembled state, the upper piston part and the lower piston part preferably have inner circumferential support elements with inner contact surfaces, and outer circumferential support elements with outer contact surfaces. In the assembled state, the inner contact surfaces, on the one hand, and the outer contact surfaces, on the other hand, lie against one another, in each instance.

An exemplary embodiment of the invention will be explained in greater detail below, using the attached drawings. The single FIGURE shows, in a schematic representation, not to scale, a section through the exemplary embodiment of a piston 10 according to the invention. The piston 10 is composed of an upper piston part 11 and a lower piston part 12. The upper piston part 11 has a piston crown 13 and a side wall having a circumferential top land 14 and a circumferential ring belt 15. The lower piston part 12 has a piston skirt 16, pin bosses 17 for accommodating the piston pin (not shown), and pin boss supports 18, which are connected with the piston skirt 16. The upper piston part 11 and the lower piston part 12 form a circumferential outer cooling channel 19 and a circumferential inner cooling channel 20.

The upper piston part 11 has a circumferential inner support element 21 having a circumferential inner contact surface 22, and a circumferential outer support element 23 having a circumferential outer contact surface 24. The lower piston part 12 also has a circumferential inner support element 25 having a circumferential inner contact surface 26, and a circumferential outer support element 27 having a circumferential outer contact surface 28.

In the assembled state, the upper piston part 11 and the lower piston part 12 are oriented, with regard to one another, in such a manner that the inner contact surface 22 of the inner support element 21 of the upper piston part 11 and the inner contact surface 26 of the inner support element 25 of the lower piston part 12 lie on top of one another. Likewise, the outer contact surface 24 of the outer support element 23 of the upper piston part 11 and the outer contact surface 28 of the outer support element 27 of the lower piston part 12 lie on top of one another.

The ring belt 15, including the outer support element 23 that follows it, as well as the inner support element 21 of the upper piston part 11, on the one hand, and the outer support element 27 and the inner support element 25 of the lower piston part 12, on the other hand, form and delimit the circumferential outer cooling channel 19 of the piston 10.

In the exemplary embodiment, a threaded bore 31 is provided on the underside of the upper piston part 11 that faces the lower piston part 12, centered in the longitudinal piston axis A. The threaded bore 31 is provided with an inside thread.

The lower piston part 12 is provided with a support plate 32 at its top, which faces the upper piston part 11. The support plate 32 is connected with the inside of the inner support element 25 of the lower piston part 12, and has a bore 33 disposed in the longitudinal piston axis A. The underside of the support plate 32 is provided with a radial contact surface 34. A screw 35 is guided in the bore 33, and screwed into the threaded bore 31. The screw 35 has a screw head 36 that is provided with a radial contact surface 37. The screw head 36 rests against the contact surface 34 on the underside of the support plate 32 with its radial contact surface 37. The upper piston part 11 and the lower piston part 12 are firmly connected with one another by means of the resulting screw connection, whereby they support one another on their corresponding contact surfaces 22 and 26, and 24 and 28, respectively. In this connection, the upper piston part 11 is drawn against the lower piston part 12. The support plate 32, which is elastic in the exemplary embodiment, as the result of the material selected and/or the design configuration, particularly its thickness, is drawn against the upper piston part 11. The screw 35 is lengthened slightly, and rests against the underside of the support plate 32. As a result, the tensile forces that occur in the screw connection are absorbed and passed directly into the lower piston part 12, by way of the support plate 32. The resulting bracing of upper piston part 11 and lower piston part 12 brings about a secure screw connection, even in high-stress operation of the piston 10.

The inner support elements 21 and 25, respectively, the support plate 33, and the screw 35 form and delimit the circumferential inner cooling channel 20.

1. Multi-part piston (10) for an internal combustion engine, having an upper piston part (11) and a lower piston part (12), whereby the lower piston part (12) has a support plate (32) on its side facing the upper piston part (11), wherein the upper piston part (11) is provided with a threaded bore (31) on its side facing the lower piston part (12), that the support plate (32) has a radial contact surface (34) on its side facing away from the upper piston part (11), against which surface a corresponding radial contact surface (36) formed on a screw (35) rests, and that the screw (35) is screwed into the threaded bore (31).

2. Piston according to claim 1, wherein the support plate (32) is configured elastically.

3. Piston according to claim 1, wherein the threaded bore (31) is configured as a dead-end bore.

4. Piston according to claim 1, wherein the lower piston part (12) has an inner circumferential support element (25), and that the support plate (32) is connected with the inner support element (25).

5. Piston according to claim 1, wherein the upper piston part (11) and the lower piston part (12) have inner, circumferential support elements (21, 25) with inner contact surfaces (22, 26), and outer circumferential support elements (23, 27) with outer contact surfaces (24, 28), and in the assembled state, the inner contact surfaces (22, 26) and the outer contact surfaces (24, 28) lie against one another, in each instance.
